(19) United States
(12) Patent Application Publication
(10) Pub. No.: US 2013/0038447 A1
(43) Pub. Date: Feb. 14, 2013

(54) ELECTRONIC LOCKING ASSEMBLY

(71) Applicants: ZHENG-QUAN PENG, Shenzhen City (CN); HAI-QING ZHOU, Shenzhen City (CN); YI-XIN TU, Shenzhen City (CN)

(72) Inventors: ZHENG-QUAN PENG, Shenzhen City (CN); HAI-QING ZHOU, Shenzhen City (CN); YI-XIN TU, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/339,378

(22) Filed: Dec. 29, 2011

(30) Foreign Application Priority Data
Aug. 8, 2011 (CN) 201110225778.9

(51) Int. Cl. G08B 21/00; G08B 29/00

(52) U.S. Cl. 340/540; 340/5.61; 340/5.28

(57) ABSTRACT

An electronic locking assembly includes an electronic lock and an electronic key for unlocking the electronic lock. The electronic key includes a first memory for storing a first password, and a first signal transceiver for encoding the first password into a first wireless signal and transmitting the first wireless signal. The electronic lock includes a main body for physically locking or unlocking the device, a second memory for storing a second password, a second signal transceiver, a processor, and a comparator. The second signal transceiver receives the first wireless signal and decodes the first wireless signal into the first password. The processor sends the first password and the second password to the comparator. The comparator compares whether the first password second password match, and thus to control the main body to physically lock or unlock the device.

### BACKGROUND

1. Technical Field

The present disclosure relates to an electronic locking assembly.

2. Description of Related Art

Electronic locking assemblies are unlocked by passwords. However, the passwords are easy to be deciphered by others, and thus the electronic locking assemblies are not secure enough.

Therefore, it is desirable to provide an electronic locking assembly that can overcome the above-mentioned limitations.

### BRIEF DESCRIPTION OF THE DRAWINGS

Many aspects of the embodiments should be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a functional block diagram of an electronic locking assembly, according to a first embodiment.

FIG. 2 is a functional block diagram of an electronic locking assembly, according to a second embodiment.

### DETAILED DESCRIPTION

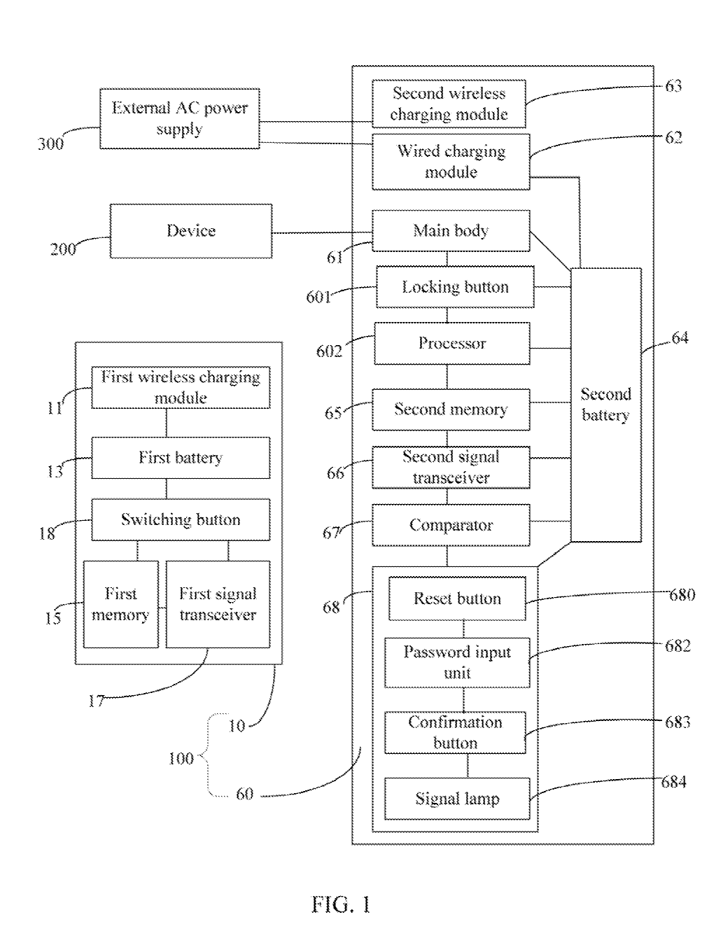

FIG. 1 is an electronic locking assembly 100, according to a first embodiment, including an electronic lock 60 for physically locking a device 200 (such as a bicycle), and an electronic key 10 for unlocking the electronic lock 60.

The electronic key 10 includes a first wireless charging module 11, a first battery 13, a first memory 15, a first signal transceiver 17, and a switching button 18. The first wireless charging module 11 is electrically connected to the first battery 13 to charge the first battery 13. In one embodiment, the first wireless charging module 11 includes a first coil, which can cooperatively form a closed electrical loop with the first battery 13. The first battery 13 is electrically connected to the first memory 15 and the first signal transceiver 17 through the switching button 18, and powers the first memory 15 and the first signal transceiver 17 when the switching button 18 is actuated.

The first memory 15 stores a first password. The first signal transceiver 17 encodes the first password into a first wireless signal and transmits the first wireless signal into the electronic lock 60.

The electronic lock 60 is integrated with the device 200, and includes a main body 61, a locking button 601, a processor 602, a wired charging module 62, a second wireless charging module 63, a second battery 64, a second memory 65, a second signal transceiver 66, a comparator 67, and a password resetting module 68.

The main body 61 physically locks or unlocks the device 200. The locking button 601 controls the main body 61 to physically lock the device 200. In this embodiment, the main body 61 has a cable like a bicycle lock, and the main body 61 locks the bicycle to a desk or a pole.

The wired charging module 62 is electrically connected between the second battery 64 and an external alternating-current (AC) power supply 300, and charges the second battery 64. The second wireless charging module 63 is electrically connected to the external power supply 300, and cooperates with the first wireless charging module 11 to charge the first battery 13. In particular, the second wireless charging module 63 includes a coil and obtains AC current from the external power supply 300 to generate a variable electromagnetic field. The first wireless charging module 11 is influenced by the variable electromagnetic field to generate induced currents to charge the first battery 13.

The second battery 64 powers the main body 61, the locking button 601, the processor 602, the second memory 65, the second signal transceiver 66, the comparator 67, and the password resetting module 68.

The second memory 65 stores a second password. The second signal transceiver 66 receives and decodes the first wireless signal into the first password. The processor 602 sends the first password from the second signal transceiver 66 and the second password in the second memory 65 to the comparator 67. The comparator 67 compares whether the first password and the second password match, and thus controls the main body 61 to unlock the device 200 or to keep the device 200 locked. In particular, if the first password and the second password match, the main body 61 unlocks the device 200, and if the first password and the second password do not match, the main body 61 keeps the device 200 locked.

The password resetting module 68 resets the first password and the second password synchronously, and includes a reset button 680, a password input unit 682, a confirmation button 683, and a signal lamp 684. The password input unit 682 may be a touch panel or a keyboard.

When the reset button 680 is actuated in an on state, the processor 602 switches the electronic locking assembly 100 to a password resetting mode. When the reset button 680 is actuated in an off state, the processor 602 switches the electronic locking assembly 100 to a normal mode (i.e. the electronic locking assembly 100 physically locks or unlocks the device 200).

When the electronic locking assembly 100 is in the password resetting mode, a user can input a number of first characters through the password input unit 685. The processor 602 further stores the first characters in the second memory 65 as a third password and sends the first characters to the second signal transceiver 66. The second signal transceiver 66 further encodes the first characters into a number of third wireless signals one by one. In addition, transmits the third wireless signals sequentially to the electronic key 10 (such as, when the password input unit 682 outputs “1”, and “1” is encoded into a third wireless signal to be transmitted first, then the password input unit 682 outputs “2”, and “2” is encoded into a third wireless signal to be transmitted next time). The first signal transceiver 17 further receives the third wireless signals and decodes the third wireless signals into a number of second characters to be stored in the first memory 15 as a fourth password.

During the password resetting process, when the electronic key 10 is within the transmitting range of third wireless signals from the second signal transceiver 66, the key 10 can receive the third wireless signals; when the electronic key 10 is outside the transmitting range of third wireless signals from the second signal transceiver 66, the key 10 can not receive the third wireless signals, therefore, sometimes, the second characters stored in the first memory 15 do not match with the first characters stored in the second memory 65.

Where upon actuation of the confirmation button 683, the processor 602 determines that the input of the third password has been finished. The first signal transceiver 17 encodes the fourth password into a fifth wireless signal and transmits the fifth wireless signal to the second signal transceiver 66, the second signal transceiver 66 receives the fifth wireless signal and decodes the fifth wireless signal into the fourth password. The processor 602 sends the third password and the fourth password to the comparator 67, the comparator 67 compares whether the third password and the fourth password match. If the third password and the fourth password match, the signal lamp 684 shows green, the first password and the second password are deleted, and the third password and the fourth password are set as new passwords of the electronic key 10 and the electronic lock 60 respectively. If the third password and the fourth password do not match, the signal lamp 684 shows red, the third password and the fourth password are deleted, the first password and the second password remain set as passwords of the electronic key 10 and the electronic lock 60 respectively.

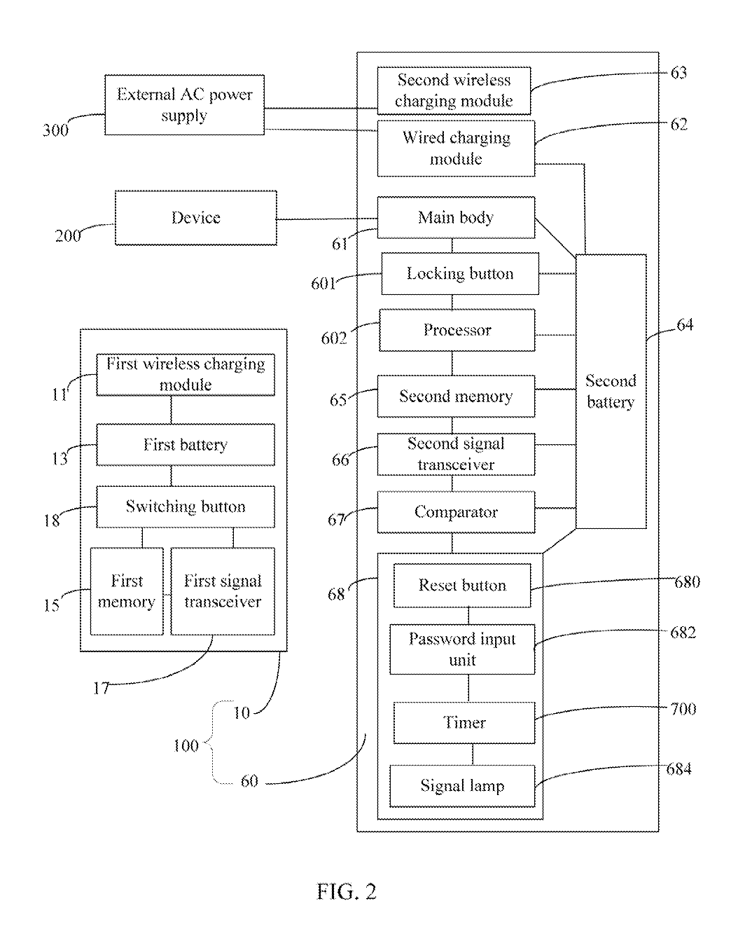

Referring to FIG. 2, according to a second embodiment, an electronic locking assembly 200 is substantially same as the electronic locking assembly 100 except that the confirmation button 683 is replaced with a timer 700.

The timer 700 stores a predetermined time interval, and tests a first time interval when the password input unit 682 does not output signal after the password input unit 682 outputs at least one signal. In addition, a second time interval when the password input unit 682 does not output any signal since the electronic locking assembly 100 is switched to the password resetting mode. The processor 602 further compares the first time interval and the second time interval tested by the timer and the predetermined time respectively, if the first time interval is greater than the predetermined time interval, the processor 602 determines that the password input has been finished. If the second time interval is greater than the predetermined time interval, the processor 602 determines that the user does not want to reset the passwords, and switches the electronic locking assembly 100 to the normal mode.

In other embodiments, the locking button 601 can be omitted, when the second signal transceiver 66 cannot receive the first wireless signal, the processor 602 controls the main body 61 to automatically lock the device 200.

It will be understood that the above particular embodiments and methods are shown and described by way of illustration only. The principles and the features of the present disclosure may be employed in various and numerous embodiments thereof without departing from the scope of the disclosure as claimed. The above-described embodiments illustrate the scope of the disclosure but do not restrict the scope of the disclosure.

What is claimed is:

1. An electronic locking assembly for a device, comprising:
an electronic key comprising:
a first memory configured for storing a first password, and
a first signal transceiver configured for encoding the first password into a first wireless signal and transmitting the first wireless signal; and
an electronic lock comprising:
a main body configured for physically locking or unlocking the device;
a second memory configured for storing a second password inputted by a user, wherein the first password and the second password match;
a second signal transceiver configured for receiving the first wireless signal and decoding the first wireless signal into the first password;
a processor configured for sending the first password and the second password to the comparator;
a comparator configured for comparing the first password from the second signal transceiver and the second password stored in the second memory to control the main body to physically unlock or lock the device.

2. The electronic locking assembly of claim 1, wherein the electronic locking assembly further comprises a locking button configured for controlling the main body to physically lock the device.

3. The electronic locking assembly of claim 1, wherein the processor controls the main body to automatically lock the device when the second signal transceiver is not capable of receiving the first wireless signal.

4. The electronic locking assembly of claim 1, wherein the electronic key further comprises a first battery and a switching button, the first battery is electrically connected to the first memory and the first signal transceiver through the switching button, and is configured for powering the first memory and the first signal transceiver when the switching button is actuated.

5. The electronic locking assembly of claim 4, wherein the electronic key further comprises a first wireless charging module, the electronic lock further comprises a second wireless charging module electrically connected to an external alternative-current power supply, the first wireless charging module and the second wireless charging module are cooperated to charge the first battery.

6. The electronic locking assembly of claim 1, wherein the electronic lock further comprises a second battery and a wired charging module, the wired charging module is electrically connected between an external alternative-current power supply and the second battery to charge the second battery, the second battery is configured for powering the main body, the locking button, the processor, the second memory, the second signal transceiver, and the comparator.

7. The electronic locking assembly of claim 1, wherein the electronic lock further comprises a password resetting module configured for resetting the first password and the second password synchronously.

8. The electronic locking assembly of claim 7, wherein the password resetting module comprises a reset button, when the reset button is actuated to an on state, the processor switches the electronic locking assembly into a password resetting mode, when the reset button is actuated in an off state, the processor switches the electronic locking assembly into a normal mode.

9. The electronic locking assembly of claim 8, wherein the password resetting module further comprises a password input unit, the password input unit is configured for inputting a plurality of first characters, the processor is further configured for storing the first characters in the second memory as a third password, and sending the first characters to the second signal transceiver, the second signal transceiver is further configured for encoding the first characters into a plurality of third wireless signals, and transmitting the third wireless signals to the first signal transceiver, the first signal transceiver is further configured for decoding the third wireless signals into a plurality of second characters, the processor is further configured for storing the second characters as a fourth password in the first memory.

10. The electronic locking assembly of claim 9, wherein the password resetting module further comprises a confirmation button, where upon actuation of the confirmation button, the processor determines that the first characters input has been finished.

11. The electronic locking assembly of claim 10, wherein the third password and the fourth password are set as new passwords of the electronic key and the electronic lock respectively.

12. The electronic locking assembly of claim 10, wherein when the third password is inputted, the first signal transceiver further decodes the fourth password into a fifth wireless signal, and transmitting the fifth wireless signal to the second signal transceiver, the second signal transceiver further decodes the fifth wireless signal into the fourth password, the processor sends the third password and the fourth password to the comparator, the comparison compares the third password and the fourth password to determine whether the third password and the fourth password match.

13. The electronic locking assembly of claim 12, wherein if the third and fourth passwords match, the first password and the second password are deleted, and the third password and the fourth password are set as new passwords of the electronic key and the electronic lock respectively; if the third and fourth passwords do not match, the third password and the fourth password are deleted, the first password and the second password remain set as passwords of the electronic key and the electronic lock respectively.

14. The electronic locking assembly of claim 12, wherein the password resetting module further comprises a signal lamp, if the third and fourth passwords match, the signal lamp shows green, if the third and fourth passwords do not match, the signal lamp shows red.

15. The electronic locking assembly of claim 9, further comprising a timer, the timer stores a predetermined time interval, and is configured for testing a first time interval when the password input unit does not output signal after the password input unit outputs at least one signal, the processor is further used for comparing the first time interval tested by the timer and the predetermined time, if the first time interval is greater than the predetermined time interval, the processor determines that the third password has been inputted.

16. The electronic locking assembly of claim 15, wherein the timer is configured for testing a second time interval when the password input unit does not output any signal since the electronic locking assembly is switched to the password resetting mode, the processor is further used for comparing the second time interval tested by the timer and the predetermined time respectively, if the second time interval is greater than the predetermined time interval, the processor switches the electronic locking assembly to the normal mode.
